(19) United States
(12) Patent Application Publication
(10) Pub. No.: US 2026/0189790 A1
(43) Pub. Date: Jul. 2, 2026

(54) CAMERA MODULE AND AUTO FOCUSING METHOD OF CAMERA MODULE

(71) Applicant: Samsung Electro-Mechanics Co., Ltd., Suwon-si (KR)

(72) Inventors: Kyunghoon CHOI, Suwon-si (KR); Jeounghee KIM, Suwon-si (KR)

(73) Assignee: Samsung Electro-Mechanics Co., Ltd., Suwon-si (KR)

(21) Appl. No.: 19/400,477

(22) Filed: Nov. 25, 2025

(30) Foreign Application Priority Data
Dec. 31, 2024 (KR) 10-2024-0202081
Sep. 24, 2025 (KR) 10-2025-0138393

(51) Int. Cl. H04N 23/68; H04N 23/90

(52) U.S. Cl. CPC H04N 23/687; H04N 23/90

(57) ABSTRACT

A method for performing an auto focusing (AF) operation of a camera system including a first camera module and a second camera module, the method including calculating a first settling time, which is a settling time of the first camera module, when the first camera module performs an AF operation of the first camera module using first Proportional Integral Derivative (PID) constant values; calculating a second settling time, which is a settling time of the second camera module, when the second camera module performs an AF operation of the second camera module using second PID constant values; resetting the second PID constant values when the second settling time is different from the first settling time; and performing, by the second camera module, the AF operation of the second camera module using the reset second PID constant values.

### CROSS-REFERENCE TO RELATED APPLICATIONS

This application claims the benefit under 35 USC 119(a) of Korean Patent Application Nos. 10-2024-0202081 filed on Dec. 31, 2024, and 10-2025-0138393 filed on Sep. 24, 2025, in the Korean Intellectual Property Office, the entire disclosures of which are incorporated herein by reference for all purposes.

### BACKGROUND

### 1. Field

The present disclosure relates to a camera module and an auto focusing method for a camera module.

### 2. Description of Background

A camera module is a main component that provides photos and images in mobile devices such as smartphones, vehicles, and smart home appliances. The camera module may include an auto focusing (AF) function that automatically focuses the camera module on a subject, an optical image stabilization (OIS) function that adjusts a camera shake, an IRIS function that controls the amount of light, and an optical zoom function that enlarges and captures a distant subject. To implement these functions, an actuator is used to apply a force to a lens unit to move the lens unit.

Recently, AR (Augmented Reality)/VR (Virtual Reality)/MR (Mixed Reality) devices that are in the spotlight are equipped with multiple camera modules. In these devices, multiple camera modules are used for various functions such as iris recognition and gesture tracking. In MR devices, multiple camera modules are used to replace human eyes, but the multiple camera modules do not include an AF function and are simply fixed focus type camera modules. The reason for using fixed focus type camera modules is that it is not easy to control AF operation of multiple camera modules simultaneously like the human eye.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of performing an auto focusing (AF) operation of a camera system including a first camera module and a second camera module includes calculating a first settling time, which is a settling time of the first camera module, when the first camera module performs an AF operation of the first camera module using first Proportional Integral Derivative (PID) constant values; calculating a second settling time, which is a settling time of the second camera module, when the second camera module performs an AF operation of the second camera module using second PID constant values; resetting the second PID constant values when the second settling time is different from the first settling time; and performing, by the second camera module, the AF operation of the second camera module using the reset second PID constant values.

The first settling time may be a time from when a lens included in the first camera module starts moving to perform the AF operation of the first camera module to when the lens included in the first camera module stops moving, and the second settling time may be a time from when a lens included in the second camera module starts moving to perform the AF operation of the second camera module to when the lens included in the second camera module stops moving.

The method may further include performing, by the first camera module, the AF operation of the first camera module using the first PID constant values when the second camera module performs the AF operation of the second camera module using the reset second PID constant values.

The method may further include setting a reference camera module among the first camera module and the second camera module.

The first camera module and the second camera module may be mounted on a Mixed Reality (MR) device.

The setting the reference camera module may include setting the first camera module as the reference camera module in response to a direction in which a person wearing the MR device is looking.

The reset second PID constant values may be PID constant values that make the second settling time equal to the first settling time.

The performing of the AF operation of the second camera module using the reset second PID constant values may include performing PID control, by the second camera module, using the reset second PID constant values to perform the AF operation of the second camera module.

In another general aspect, a camera system includes a first camera module; a second camera module; and a controller configured to control auto focusing (AF) operations of the first and second camera modules, wherein the controller is further configured to calculate a settling time of the first camera module when the first camera module performs an AF operation of the first camera module using first Proportional Integral Derivative (PID) constant values; calculate a settling time of the second camera module when the second camera module performs an AF operation of the second camera module using second PID constant values; reset PID constant values of the second camera module when the settling time of the second camera module is different from the settling time of the first camera module; and control the second camera module to perform the AF operation of the second camera module using the reset PID constant values.

The settling time of the first camera module may be a time from when a lens included in the first camera module starts moving to perform the AF operation of the first camera module to when the lens included in the first camera module stops moving, and the settling time of the second camera module may be a time from when a lens included in the second camera module starts moving to perform the AF operation of the second camera module to when the lens included in the second camera module stops moving.

The controller may be further configured to set a reference camera module among the first camera module and the second camera module.

The first camera module and the second camera module may be mounted on a Mixed Reality (MR) device.

The controller may be further configured to set the first camera module as the reference camera module in response to a direction in which a person wearing the MR device is looking.

The reset PID constant values may be PID constant values that make the settling time of the second camera module equal to the settling time of the first camera module.

The second camera module may perform PID control using the reset PID constant values to perform the AF operation of the second camera module.

Other features and aspects will be apparent from the following detailed description, the drawings, and the claims.

### BRIEF DESCRIPTION OF DRAWINGS

FIG. 1 is a block diagram showing a camera system 1000 according to an embodiment.

FIG. 2 is a drawing showing a first camera module 300A and a second camera module 300B mounted on an MR device.

FIG. 3A is a block diagram showing an internal configuration of a first actuator 330A.

FIG. 3B is a block diagram showing an internal configuration of a second actuator 330B.

FIG. 4 is a flowchart showing a method by which the camera system 1000 controls settling times of the first and second camera modules 300A and 300B.

FIG. 5A is a graph conceptually representing a position of a first lens 340A during an AF operation of the first camera module 300A.

FIG. 5B is a graph conceptually representing a position of a second lens 340B during an AF operation of the second camera module 300B.

FIG. 6 is a flowchart showing a method by which the camera system 1000 performs an operation to match a settling time TST2 of the second camera module 300B to a settling time TST1 of the first camera module 300A. That is, the flowchart of FIG. 6 is a flowchart showing a specific operation of S440 in FIG. 4.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The use of the term “may” with respect to an example or embodiment, e.g., as to what an example or embodiment may include or implement, means that at least one example or embodiment exists in which such a feature is included or implemented, while all examples and embodiments are not necessarily limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween, or the elements may be physically connected as well as electrically connected, or the elements may be integral despite being referred to by different names according to position or function. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

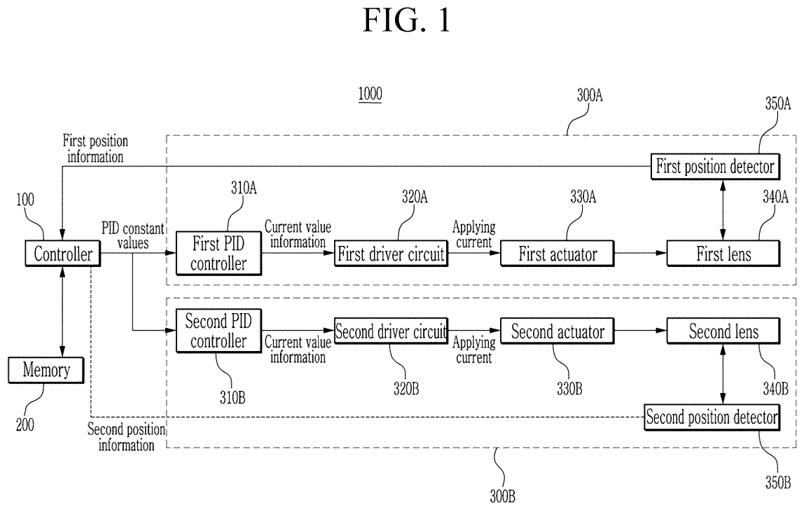

FIG. 1 is a block diagram showing a camera system 1000 according to an embodiment.

As shown in FIG. 1, the camera system 1000 according to an embodiment may include a controller 100, a memory 200, a first camera module 300A, and a second camera module 300B.

The controller 100 controls the overall operation of the first camera module 300A and the second camera module 300B. According to an embodiment, the controller 100 may control the first camera module 300A and the second camera module 300B to perform an auto focusing (AF) operation. A settling time of the first camera module 300A and a settling time of the second camera module 300B may be different from each other, and the controller 100 may control the two different settling times to be the same.

The settling time of the first camera module 300A may be defined as follows. As an example, the settling time of the first camera module 300A may be the time taken from the time when a lens of the first camera module 300A (i.e., a first lens 340A of FIG. 1) begins to move to perform the AF operation until the time when the lens of the first camera module 300A reaches the final position and becomes stable. As another example, the settling time of the first camera module 300A may be the time taken from the time when a current is applied to an actuator of the first camera module 300A (i.e., a first actuator 330A of FIG. 1) to perform the AF operation until the time when the lens of the first camera module 300A (i.e., the first lens 340A) reaches the final position and becomes stable. Hereinafter, for convenience, the settling time of the first camera module 300A is referred to as ‘TST1’.

The settling time of the second camera module 300B may be defined as follows. As an example, the settling time of the second camera module 300B may be the time taken from the time a lens of the second camera module 300B (i.e., a second lens 340B of FIG. 1) begins to move to perform the AF operation until the time the lens of the second camera module 300B reaches the final position and becomes stable. As another example, the settling time of the second camera module 300B may be the time taken from the time when a current is applied to the actuator of the second camera module 300B (i.e., a second actuator 330B of FIG. 1) to perform the AF operation until the time when the lens of the second camera module 300B (i.e., the second lens 340B) reaches the final position and becomes stable. Hereinafter, for convenience, the settling time of the second camera module 300B is referred to as ‘TST2’.

The memory 200 stores PID (Proportional Integral Derivative) constant values (Kp, Ki, Kd) used to perform the AF operations of the first camera module 300A and second camera module 300B. The first camera module 300A and the second camera module 300B perform the AF operation through PID control, and the PID constant values are used for this. The PID constant values are stored in the memory 200 in advance when designing the camera system 1000. The PID constant values may have different values depending on the settling time of the first camera module 300A and the settling time of the second camera module 300B. Hereinafter, the PID constant values used for AF control of the first camera module 300A are referred to as ‘first PID constant values Kp1, Ki1, and Kd1’, and the PID constant values used for AF control of the second camera module 300B are referred to as ‘second PID constant values Kp2, Ki2, and Kd2’.

The memory 200 may include various forms of volatile or non-volatile storage media. For example, the memory 200 may include read-only memory (ROM) and random-access memory (RAM). As an example, the memory 200 may be disposed internally in the controller 100 or externally to the controller 100, and the memory 200 may be connected to the controller 100 via various means already known in the art.

The first camera module 300A and the second camera module 300B may be mounted at predetermined locations in an electronic device. That is, the first camera module 300A and the second camera module 300B may be mounted on an augmented reality (AR)/virtual reality (VR)/Mixed Reality (MR) device. As an example, the first camera module 300A and the second camera module 300B may be mounted on an MR device.

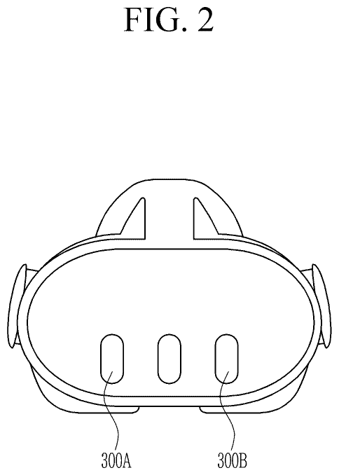

FIG. 2 is a drawing showing a first camera module 300A and a second camera module 300B mounted on an MR device.

In FIG. 2, the first camera module 300A and the second camera module 300B may act as the eyes of a person using an MR device. That is, the first camera module 300A may capture an image corresponding to the right eye and provide it to the MR device, and the second camera module 300B may capture an image corresponding to the left eye and provide it to the MR device. Hereinafter, for better understanding and ease of description, the camera system 1000 is described as including two camera modules 300A and 300B, but this description may also be applied to a case where the camera system 1000 includes three or more camera modules.

As shown in FIG. 1, the first camera module 300A according to the embodiment may include a first PID controller 310A, a first driver circuit 320A, a first actuator 330A, a first lens 340A, and a first position detector 350A.

The first PID controller 310A receives the first PID constant values Kp1, Ki1, and Kd1 from the controller 100, and performs PID control using the first PID constant values Kp1, Ki1, and Kd1. That is, the first PID controller 310A performs P (Proportional) control, I (integral) control, and D (Derivative) control using the first PID constant values Kp1, Ki1, and Kd1. The first PID controller 310A may output current value information determined through PID control. Here, the current value information may be digital data. The first PID controller 310A may receive first position information (information about the position of the first lens 340A detected by the first position detector 350A, which is described below) from the controller 100 for PID control.

P (Proportional) control determines a control output in proportion to the size of the current error. If the error is large, the lens may be controlled to move a large distance, and if the error is small, the lens may be controlled to move a small distance.

I (integral) control determines a control output in proportion to the sum of errors accumulated from the past. Through I control, fine steady-state errors that cannot be resolved by P control alone may be removed.

D (Derivative) control determines a control output in proportion to the change rate of error (a predicted future error). D control may be used to brake when the error rapidly approaches the target rate. That is, D control reduces overshoot and increases stability (damping), which allows the lens to settle smoothly at the target position.

The first driver circuit 320A receives the current value information for PID control from the first PID controller 310A, and may generate a current to be applied to the first actuator 330A in response to the received current value information. Here, the current value information received from the first PID controller 310A may be a digital signal, and the first driver circuit 320A may include a DAC (Digital-to-Analog Converter) that converts the digital signal into an analog signal. Meanwhile, the first driver circuit 320A may further include an amplifier circuit that converts a weak analog signal into a strong driving signal. As an example, the amplification circuit may be an H-bridge circuit. The H-bridge circuit is composed of transistors that act as four switches. A person with ordinary skill in the technical field of this description would know this, so a detailed description of the H-bridge circuit is omitted.

The first actuator 330A may be driven by the current generated by the first driver circuit 320A. The first actuator 330A is driven by the current and moves the first lens 340A in an optical axis direction.

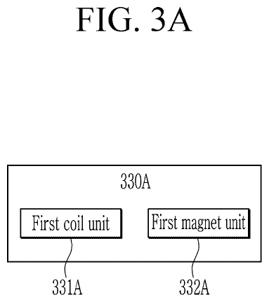

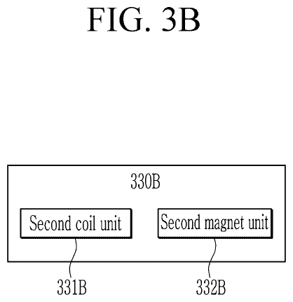

FIG. 3A is a block diagram showing an internal configuration of a first actuator 330A.

As shown in FIG. 3A, the first actuator 330A may include a first coil unit 331A and a first magnet unit 332A. As an example, the first coil unit 331A may be placed in a housing of the first camera module 300A, and the first magnet unit 332A may be placed in or on a lens barrel that accommodates the first lens 340A. When the current generated in the first driver circuit 320A is applied to the first coil section 331A, a Lorentz force is generated between the first coil unit 331A and the first magnet unit 332A. Due to this, the first lens 340A may move in the optical axis direction and perform the AF operation.

The first lens 340A may be accommodated in the lens barrel, and the first lens 340A may be composed of one or a plurality of lenses. When the first lens 340A is composed of a plurality of lenses, the plurality of lenses may be aligned along the optical axis and mounted in the lens barrel. Here, a plurality of lenses may have optical characteristics such as the same or different refractive indices.

The first position detector 350A detects a position of the first lens 340A. The first lens 340A moves along the optical axis direction for the AF operation, and the first position detector 350A may detect the position of the moving first lens 340A. As an example, the first position detector 350A may be implemented with a Hall IC (Integrated Circuit). The Hall IC may detect the position of the first lens 340A through a magnetic force generated by the first magnet 332A placed in or on the lens barrel. The first position detector 350A may transmit information about the position of the detected first lens 340A (hereinafter referred to as ‘first position information’) to the controller 100. The controller 100 may transmit the received first position information to the first PID controller 310A, and the first PID controller 310A may use the first position information for PID control.

As shown in FIG. 1, the second camera module 300B according to the embodiment may include a second PID controller 310B, a second driver circuit 320B, a second actuator 330B, a second lens 340B, and a second position detector 350B.

The second PID controller 310B receives the second PID constant values Kp2, Ki2, and Kd2 from the controller 100, and performs PID control using the second PID constant values Kp2, Ki2, and Kd2. That is, the second PID controller 310B performs P (Proportional) control, I (integral) control, and D (Derivative) control using the second PID constant values Kp2, Ki2, and Kd2. The second PID controller 310B may output current value information determined through PID control. Here, the current value information may be digital data. The second PID controller 310B may receive second position information (information about the position of the second lens 340B detected by the second position detector 350B, which is described below) from the controller 100 for PID control. Here, P (Proportional) control, I (integral) control, and D (Derivative) control are the same as those described above, so a detailed explanation is omitted.

The second driver circuit 320B receives the current value information for PID control from the second PID controller 310B, and may generate a current to be applied to the second actuator 330B in response to the received current value information. Here, the current value information received from the second PID controller 310B may be a digital signal, and the second driver circuit 320B may include a DAC (Digital-to-Analog Converter) that converts the digital signal into an analog signal. Meanwhile, the second driver circuit 320B may further include an amplifier circuit that converts a weak analog signal into a strong driving signal. As an example, the amplification circuit may be an H-bridge circuit. The H-bridge circuit is composed of transistors that act as four switches. A person with ordinary skill in the technical field of this description would know this, so a detailed description is omitted.

The second actuator 330B may be driven by the current generated by the second driver circuit 320B. The second actuator 330B is driven by the current and moves the second lens 340B in the optical axis direction.

FIG. 3B is a block diagram showing an internal configuration of a second actuator 330B.

As shown in FIG. 3B, the second actuator 330B may include a second coil unit 331B and a second magnet unit 332B. As an example, the second coil unit 331B may be placed in a housing of the second camera module 300B, and the second magnet unit 332B may be placed in or on a lens barrel that accommodates the second lens 340B. When the current generated in the second driver circuit 320B is applied to the second coil unit 331B, a Lorentz force is generated between the second coil unit 331B and the second magnet unit 332B. Due to this, the second lens 340B may move in the optical axis direction and perform the AF operation.

The second lens 340B may be accommodated in the lens barrel, and the second lens 340B may be composed of one or a plurality of lenses. When the second lens 340B is composed of a plurality of lenses, the plurality of lenses may be aligned along the optical axis and mounted in the lens barrel. Here, a plurality of lenses may have optical characteristics such as the same or different refractive indices.

The second position detector 350B detects a position of the second lens 340B. The second lens 340B moves along the optical axis direction for the AF operation, and the second position detector 350B may detect the position of the moving second lens 340B. As an example, the second position detector 350B may be implemented with a Hall IC (Integrated Circuit). The Hall IC may detect the position of the second lens 340B through a magnetic force generated by the second magnet 332B placed in the lens barrel. The second position detector 350B may transmit information about the position of the detected second lens 340B (hereinafter referred to as ‘second position information’) to the controller 100. The controller 100 may transmit the received second position information to the second PID controller 310B, and the second PID controller 310B may use the second position information for PID control.

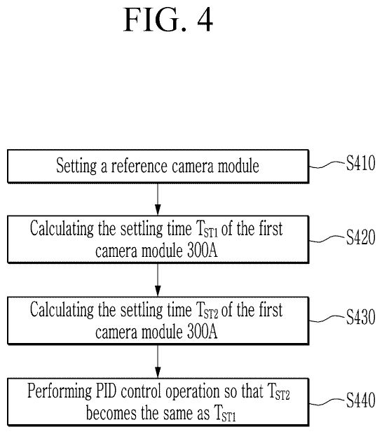

Hereinafter, referring FIGS. 4 to 6, a method for controlling the settling times of the first and second camera modules 300A and 300B when the camera system 1000 performs the AF operation is described.

FIG. 4 is a flowchart showing a method by which the camera system 1000 controls settling times of the first and second camera modules 300A and 300B.

First, the camera system 1000 sets a reference camera module among the first camera module 300A and the second camera module 300B to be used as a reference for adjusting a settling time (S410). When the first camera module 300A and the second camera module 300B are mounted on the MR device as shown in FIG. 2, the reference camera module may be set as follows. When a person wearing the MR device of FIG. 2 turns his head to the left, the second camera module 300B may be set as the reference camera module. When a person wearing the MR device of FIG. 2 turns his head to the right, the first camera module 300A may be set as the reference camera module. Here, although not shown in FIG. 2, a gyro sensor may be installed in the MR device, and it may be determined through the gyro sensor whether the MR device is moving to the left or right. In the following, for better understanding and ease of description, it is assumed that the first camera module 300A is set as the reference camera module.

The camera system 1000 calculates the settling time TST1 of the first camera module 300A (S420). The controller 100 of the camera system 1000 retrieves the first PID constant values Kp1, Ki1, and Kd1 stored in the memory 200 to perform the AF operation for the first camera module 300A. The controller 100 of the camera system 1000 transmits the first PID constant values Kp1, Ki1, and Kd1 to the first camera module 300A, and the first camera module 300A performs the AF operation using the first PID constant values Kp1, Ki1, and Kd1. At this time, the controller 100 of the camera system 1000 receives the first position information, which is position information of the first lens 340A, from the first position detector 350A. The controller 100 may use the first position information to calculate the settling time TST1 of the first camera module 300A. That is, the controller 100 may calculate the point in time when the first lens 340A starts moving through the first position information, and calculate the point in time when the first lens 340A stops moving through the first position information. The controller 100 may calculate the time difference between these two points in time to finally calculate the settling time TST1 of the first camera module 300A.

The camera system 1000 calculates the settling time TST2 of the second camera module 300B (S430). The controller 100 of the camera system 1000 retrieves the second PID constant values Kp2, Ki2, and Kd2 stored in the memory 200 to perform the AF operation for the second camera module 300B. The controller 100 of the camera system 1000 transmits the second PID constant values Kp2, Ki2, and Kd2 to the second camera module 300B, and the second camera module 300B performs the AF operation using the second PID constant values Kp2, Ki2, and Kd2. At this time, the controller 100 of the camera system 1000 receives the second position information, which is position information of the second lens 340B, from the second position detector 350B. The controller 100 may use the second position information to calculate the settling time TST2 of the second camera module 300B. That is, the controller 100 may calculate the point in time when the second lens 340B starts moving through the second position information, and calculate the point in time when the second lens 340B stops moving through the second position information. The controller 100 may calculate the time difference between these two points in time to finally calculate the settling time TST2 of the second camera module 300B.

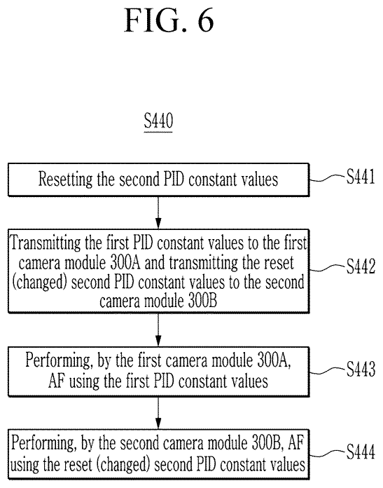

The camera system 1000 performs a PID control operation so that the settling time TST2 of the second camera module 300B calculated in S430 becomes the same as the settling time TST1 of the first camera module 300A calculated in S420 (S440). That is, if the settling time TST2 of the second camera module 300B calculated in S430 is different from the settling time TST1 of the first camera module 300A calculated in S420, the camera system 1000 performs a PID control operation to match the settling time TST2 of the second camera module 300B to the settling time TST1 of the first camera module 300A. The specific operation of S440 is described in more detail in FIG. 6 below.

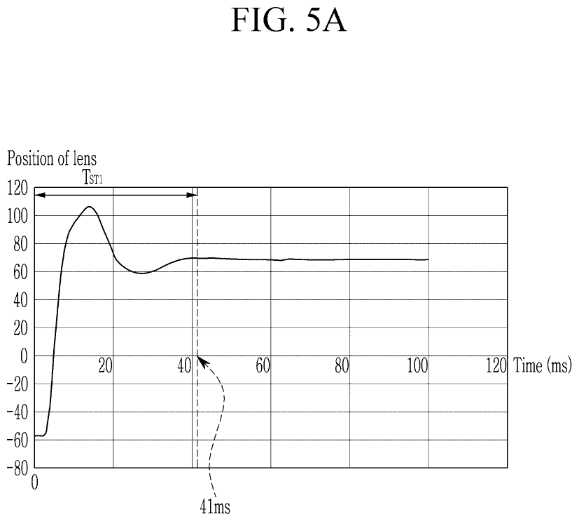

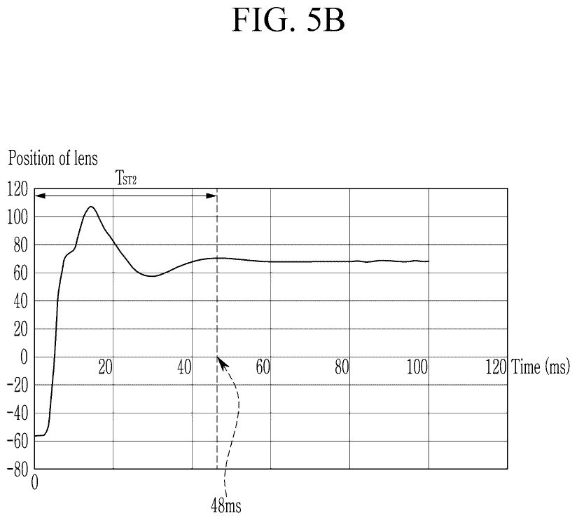

FIG. 5A is a graph conceptually representing a position of a first lens 340A during an AF operation of the first camera module 300A. FIG. 5B is a graph conceptually representing a position of a second lens 340B during an AF operation of the second camera module 300B.

In FIG. 5A and FIG. 5B, the horizontal axis represents time, and the vertical axis conceptually represents the position of the lens. The horizontal axis has units in ms, and the vertical axis has no units and represents the relative position in the optical axis direction.

Referring to FIG. 5A, in the AF operation, at 0 ms, the first lens 340A starts moving, and at 41 ms the first lens 340A stops moving and becomes stable. Accordingly, the controller 100 may calculate the settling time TST1 of the first camera module 300A as 41 ms.

Referring to FIG. 5B, in the AF operation, at 0 ms the second lens 340B starts moving, and at 48 ms the second lens 340B stops moving and becomes stable. Accordingly, the controller 100 may calculate the settling time TST2 of the second camera module 300B as 48 ms.

That is, the settling time TST2 of the second camera module 300B is 48 ms, and the settling time TST1 of the first camera module 300A is 41 ms. Accordingly, the controller 100 may perform a PID control operation so that the settling time TST2 of the second camera module 300B may be changed from 48 ms to 41 ms.

FIG. 6 is a flowchart showing a method by which the camera system 1000 performs an operation to match a settling time TST2 of the second camera module 300B to a settling time TST1 of the first camera module 300A. That is, the flowchart of FIG. 6 is a flowchart showing a specific operation of S440 in FIG. 4.

First, camera system 1000 resets or changes the second PID constant values Kp2, Ki2, and Kd2, which are the PID constant values of the second camera module 300B (S441). The controller 100 of camera system 1000 resets or changes the second PID constant values Kp2, Ki2, and Kd2 so that the settling time TST2 of the second camera module 300B becomes the same as the settling time TST1 of the first camera module 300A. At this time, the controller 100 of camera system 1000 does not reset or change the first PID constant values Kp1, Ki1, and Kd1, which are the PID constant values of the first camera module 300A. As described above, the memory 200 stores the PID constant values corresponding to the settling time of the first camera module 300A and the settling time of the second camera module 300B. Hereinafter, for better understanding and ease of description, the second PID constant values that make the settling time TST2 of the second camera module 300B the same as the settling time TST1 of the first camera module 300A are referred to as ‘reset (changed) second PID values Kp2′, Ki2′, Kd2′’. That is, the controller 100 of camera system 1000 retrieves the reset (changed) second PID constant values Kp2′, Ki2′, Kd2′ stored in the memory 200 to change the settling time of second camera module 300B.

The controller 100 of the camera system 1000 transmits the first PID constant values Kp1, Ki1, and Kd1 to the first camera module 300A and transmits the reset (changed) second PID constant values Kp2′, Ki2′, Kd2′ to the second camera module 300B (S442). Since the first camera module 300A is the reference camera module and does not need to adjust the settling time, the controller 100 of the camera system 1000 may transmit the first PID constant values Kp1, Ki1, and Kd1 used in S420 to the first camera module 300A. Since the second camera module 300B needs to adjust the settling time, the controller 100 of the camera system 1000 may transmit the second PID constant values Kp2′, Ki2′, Kd2′ that are reset (changed) in S441 to the second camera module 300B.

The first camera module 300A performs the AF operation using the first PID constant values Kp1, Ki1, and Kd1 received in S442 (S443). That is, the first PID controller 310A of the first camera module 300A performs PID control using the first PID constant values Kp1, Ki1, and Kd1 that have not been changed. The first PID controller 310A of the first camera module 300A performs P (Proportional) control, I (integral) control, and D (Derivative) control using the unchanged first PID constant values Kp1, Ki1, and Kd1. Since the settling time of the first camera module 300A does not need to be changed, S443 may be omitted.

The second camera module 300B performs the AF operation using the reset (changed) second PID constant values Kp2′, Ki2′, Kd2′ received in S442 (S444). That is, the second PID controller 310B of the second camera module 300B performs PID control using the reset (changed) second PID constant values Kp2′, Ki2′, Kd2′. The second PID controller 310B of the second camera module 300B performs P (Proportional) control, I (integral) control, and D (Derivative) control using the reset (changed) second PID constant values Kp2′, Ki2′, Kd2′. Since the second camera module 300B performs the AF operation using the reset (changed) second PID constant values Kp2′, Ki2′, Kd2′, the settling time TST2 of the second camera module 300B may become the same as the settling time TST1 of the first camera module 300A. In the case of FIG. 5A and FIG. 5B, the settling time TST2 of the second camera module 300B in FIG. 5B may be changed from 48 ms to 41 ms.

In this way, when the settling time TST2 of the second camera module 300B becomes the same as the settling time TST1 of the first camera module 300A, the MR device of FIG. 2 may simultaneously display images captured through the first and second camera modules 300A and 300B. Since the first camera module 300A and the second camera module 300B perform the AF operation simultaneously like the human eye, a user wearing the MR device of FIG. 2 may experience an AF operation similar to that of the human eye.

According to at least one embodiment of the embodiments, by setting the settling time for the plurality of camera modules to be the same, the AF operation may be performed simultaneously for the plurality of camera modules.

While this disclosure includes specific embodiments, it will be apparent after an understanding of the disclosure of this application that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of performing an auto focusing (AF) operation of a camera system comprising a first camera module and a second camera module, the method comprising:
calculating a first settling time, which is a settling time of the first camera module, when the first camera module performs an AF operation of the first camera module using first Proportional Integral Derivative (PID) constant values;
calculating a second settling time, which is a settling time of the second camera module, when the second camera module performs an AF operation of the second camera module using second PID constant values;
resetting the second PID constant values when the second settling time is different from the first settling time; and
performing, by the second camera module, the AF operation of the second camera module using the reset second PID constant values.

2. The method of claim 1, wherein the first settling time is a time from when a lens included in the first camera module starts moving to perform the AF operation of the first camera module to when the lens included in the first camera module stops moving, and
the second settling time is a time from when a lens included in the second camera module starts moving to perform the AF operation of the second camera module to when the lens included in the second camera module stops moving.

3. The method of claim 1, further comprising performing, by the first camera module, the AF operation of the first camera module using the first PID constant values when the second camera module performs the AF operation of the second camera module using the reset second PID constant values.

4. The method of claim 1, further comprising setting a reference camera module among the first camera module and the second camera module.

5. The method of claim 4, wherein the first camera module and the second camera module are mounted on a Mixed Reality (MR) device.

6. The method of claim 5, wherein the setting the reference camera module comprises setting the first camera module as the reference camera module in response to a direction in which a person wearing the MR device is looking.

7. The method of claim 1, wherein the reset second PID constant values are PID constant values that make the second settling time equal to the first settling time.

8. The method of claim 1, wherein the performing of the AF operation of the second camera module using the reset second PID constant values comprises performing PID control, by the second camera module, using the reset second PID constant values to perform the AF operation of the second camera module.

9. A camera system comprising:
a first camera module;
a second camera module; and
a controller configured to control auto focusing (AF) operations of the first and second camera modules,
wherein the controller is further configured to:
calculate a settling time of the first camera module when the first camera module performs an AF operation of the first camera module using first Proportional Integral Derivative (PID) constant values;
calculate a settling time of the second camera module when the second camera module performs an AF operation of the second camera module using second PID constant values;
reset PID constant values of the second camera module when the settling time of the second camera module is different from the settling time of the first camera module; and
control the second camera module to perform the AF operation of the second camera module using the reset PID constant values.

10. The camera system of claim 9, wherein the settling time of the first camera module is a time from when a lens included in the first camera module starts moving to perform the AF operation of the first camera module to when the lens included in the first camera module stops moving, and
the settling time of the second camera module is a time from when a lens included in the second camera module starts moving to perform the AF operation of the second camera module to when the lens included in the second camera module stops moving.

11. The camera system of claim 9, wherein the controller is further configured to set a reference camera module among the first camera module and the second camera module.

12. The camera system of claim 11, wherein the first camera module and the second camera module are mounted on a Mixed Reality (MR) device.

13. The camera system of claim 12, wherein the controller is further configured to set the first camera module as the reference camera module in response to a direction in which a person wearing the MR device is looking.

14. The camera system of claim 9, wherein the reset PID constant values are PID constant values that make the settling time of the second camera module equal to the settling time of the first camera module.

15. The camera system of claim 9, wherein the second camera module performs PID control using the reset PID constant values to perform the AF operation of the second camera module.
